(19) United States
(12) Patent Application Publication
(10) Pub. No.: US 2008/0165782 A1
(43) Pub. Date: Jul. 10, 2008

(54) Method for Data Interchange Between Network Elements

(75) Inventor: Mohammad Vizaei, Wien (AT)

Correspondence Address: BELL, BOYD & LLOYD, LLP, P.O. BOX 1135, CHICAGO, IL, 60690, US

(73) Assignee: Nokia Siemens Network GmbH & Co. KG, Munchen (DE)

(21) Appl. No.: 11/997,276

(22) PCT Filed: Jul. 28, 2006
(86) PCT No.: PCT/EP2006/064781

§ 371 Date: Mar. 17, 2008

(30) Foreign Application Priority Data
Jul. 29, 2005 (DE) 10 2005 035 733.4

(51) Int. Cl. H04L 12/58

(52) U.S. Cl. 370/392

(57) ABSTRACT

The invention relates to a method for data exchange between at least one calling network element and at least one network element to be called, in different first and second network areas separated by network node devices or firewalls. A network address which is locally valid only in the respective network area is generally associated with the network elements in said separated network areas or domains. Said locally valid network address is converted into message header entries, which send the network elements to network elements localised outside the network region, by the respective network node device, by means of a network address which is valid outside the respective network area, especially a globally valid network address of the network node element. According to the invention, following the emission of an invite message (e.g. an SIP invite), the content of the invite message is modified on the basis of the network address which is contained in the message header and valid outside the first network area, e.g. an entry of the IP address contained in the header and previously modified by the network nodes, in a body of the message. The second network element to be called then sends a message towards the first calling network element. Said message generates a continuous filter or pinhole in the second network node device and is dropped on the first network node device. A confirmation message is sent by the network element to be called. Said confirmation message is provided, for example, by the used communication protocol, for example SIP, and is modified analogously to the invite message, for example on a switch or network node arranged between the network node devices. Analogously, a message generating a continuous filter for the first network node device is sent by the network element to be called once the confirmation message has been received. In this way, an RTP connection (Real Time Protocol) can be established between the calling network element and the network element to be called, without any further consideration of the address conversion NAT between the two communicating network elements.

### CLAIM FOR PRIORITY

This application is a national stage of PCT/EP2006/064781, filed Jul. 28, 2006, which claims the benefit of DE 10 2005 035 733.4, filed Jul. 29, 2005, the contents of which are hereby incorporated by reference.

### TECHNICAL FIELD OF THE INVENTION

The invention relates to a method for data interchange for network elements which are arranged in different network areas.

### BACKGROUND OF THE INVENTION

It is known for network node devices, for example routers, firewalls or gateways, to be used to support and to protect a data interchange between network elements which are arranged in different local packet-oriented network areas.

By way of example, a packet-oriented data interchange takes place using the Internet Protocol, also referred to for short as IP. The following description occasionally refers to the Internet Protocol, although use of this protocol should be regarded only as an example. A packet-oriented data interchange comprises all packet-oriented communication matters in which data packets used for data interchange are composed of a data part and a characterizing part—often referred to in the literature as the “header”. In this case, the header normally contains a sender address, which characterizes the transmitting network element, and also a destination address, which characterizes the network element intended for reception.

When using “local” addresses, which are valid only within a first local network area, for addressing a network element, the addresses which are locally valid in the first network must be converted to addresses which are valid for the second network area in order to communicate with network elements in a second network area. In this case, the respective IP address of the transmitting network element and of the network element that is intended to receive are respectively used as the sender address and the destination address. A corresponding method, also referred to in the specialist world as an address translation or NAT (Network Address Translation), is normally carried out by a network node device, for example on the basis of allocation tables.

The IETF (Internet Engineering Task Force) document RFC 3027 (Request for Comment) quotes various applications and communication protocols whose use leads to problems with the abovementioned address translation.

So-called “Bundled Session Applications” in this case represent a category of applications that are subject to problems and whose packet-oriented data interchange includes addressing information being contained not only in the header but also in the data part (“Payload”) of a respective data packet.

Since the addressing information contained in the payload, in the same way as that contained in the header, is normally domain-specific, that is to say it is valid only in a respective network area, this addressing information is invalid after being transferred to a different network area, even with address translation having been carried out, since network node devices normally convert only address information in the header of such data packets using the NAT method.

One exception to this is offered by network node devices which are in the form of so-called “Application Layer Gateways” or ALG for short. These ALG also take account of address information contained in the payload for NAT-analogous address translation. ALGs such as these must, however, be designed specifically for the respective protocol and are subject to further delay-time and performance problems because of the computation time required for evaluation and conversion of the payload data. One example of the abovementioned bundled session applications is, inter alia, the SIP (Session Initiated Protocol) or H.323 communication protocols that are known in the specialist world. The SIP protocol is frequently used in order to manage any desired communication links or “Sessions” with one or more subscribers. One possible communication link is in this case VoIP telephony (Voice over Internet Protocol), or else any desired multimedia streams, conferences, computer games, etc. The SIP protocol is used to allow the communication link, with the actual data for communication being interchanged using other protocols. By way of example, two of these protocols are referred to in the following text.

The communication link is managed using a Session Description Protocol (SDP) in accordance with RFC 2327. An interchange of network addresses—for example IP addresses—and interfaces or ports to communication partners is or are provided for this purpose. Furthermore SDP covers negotiation of codecs, transport protocols etc. to be used between the communication partners.

The payload data or payload is transported using a real time transport protocol (RTP) in accordance with RFC 3550. By way of example, transport by RTP comprises subdivision of the payload data which, for example, is coded and compressed using a codec, into data packets, and their dispatch. Dispatch takes place, for example, using a transport protocol such as UDP (User Datagram Protocol).

Use of an ALG to allow a data interchange such as a communication link is frequently restricted to one specific protocol such as SIP. Furthermore, both network areas must have an identically configured ALG, that is to say an ALG matched to the communication protocol being used.

### SUMMARY OF THE INVENTION

The invention relates to data interchange between network node devices, which convert network addresses in a characterizing area of interchanged data packets, in separate network elements, which ensures valid addressing, in the respective other network area, of the transmitting network element on the basis of the addressing information entered in a data area of interchanged data packets.

In one embodiment of the invention, there is a method to provide at least one calling network element and at least one network element to be called in different first and second network areas, which are separated by network node devices and firewalls. In these separate network areas or domains, the network elements are normally allocated a network address which is locally valid in the respective network area. This locally valid network address in message header entries or headers of messages which the network elements send to network elements located outside their own network area is converted by the respective network node device by means of a network address which is valid outside the respective network area, in particular by a globally valid network address of the network node element. The invention provides that, after sending an invitation message (for example an SIP invite), the content of the invitation message is modified on the basis of the network address which is contained in the message header entry and is valid outside the first network area, that is for example an entry of the IP address which is contained in the header and has already been modified by the network node unit, in a body of the message. The second network element to be called then sends a message in the direction of the calling first network element. This message produces a pass filter or pinhole in the second network node device, and is rejected or “dropped” at the first network node device. A confirmation message is then sent by the network element to be called. By way of example, this confirmation message is provided by means of the communication protocol being used, for example SIP. This confirmation message is modified analogously to the invitation message, for example at a switch or network node arranged between the network node devices. Analogously to the above procedure, a message which produces a pass filter for the first network node device is now sent by the network element to be called, after receiving the confirmation message. This allows an RTP link (Real Time Protocol) to be set up between the calling network element and the network element to be called, without further consideration of the address translation NAT between the two communicating network elements.

One advantage of the invention is that a network node device of this normal generic type, in particular a gateway or router, can be used to connect the two network areas without any further configuration actions.

The invention can advantageously be implemented in the network elements, that is the end points of a packet-oriented communication, and therefore requires only a small amount of programming effort and, in particular, no actions on the overall system or in the switching network node devices.

### BRIEF DESCRIPTION OF THE DRAWINGS

One exemplary embodiment together with further advantages and refinements of the invention will be explained in more detail in the following text, with reference to the drawing, in which:

FIG. 1 shows a chronological flowchart in order to schematically illustrate one function of a firewall that is known from the prior art.

FIG. 2A shows a structogram in order to schematically illustrate a communication environment.

FIG. 2B shows a chronological flowchart in order to schematically illustrate a message interchange according to the invention, in order to set up a communication link.

### DETAILED DESCRIPTION OF THE INVENTION

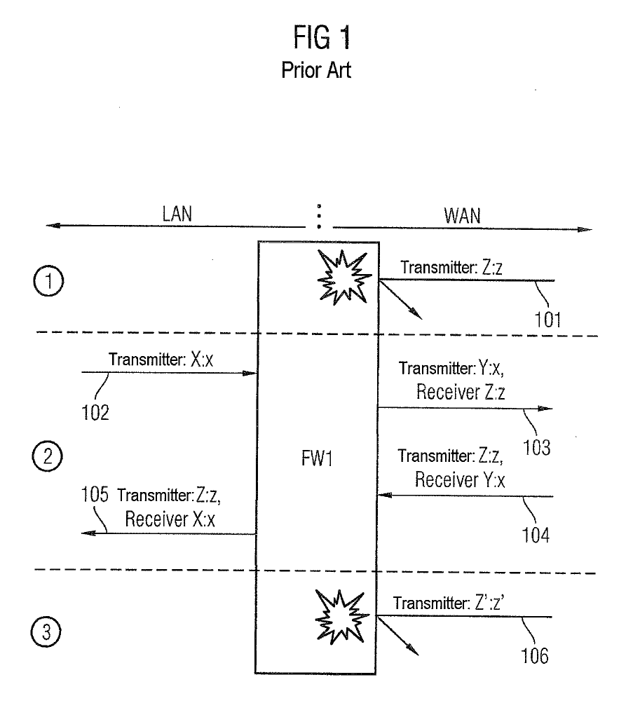

FIG. 1 shows a firewall or gateway which is known from the prior art, in which a network address translation or NAT is carried out. An illustrated firewall FW1 is normally arranged between a local area network or LAN and a public network WAN. The firewall is therefore, in more general terms, arranged between two domains. The firewall FW1 which will be described in the following text is referred to in the following text by the more general expression network node device FW1, since its functionality can also be implemented in a gateway, in a router or in an NAT server.

In a first case, which is represented by a circled number 1 in FIG. 1, it is assumed that a message 101 arrives at the network node device FW1 having originated from a transmitting element, not illustrated, and is characterized by a network address Z and an interface z (“transmitter: Z:z” in the drawing). The network address preferably corresponds to an IP address, and the interface is characterized by a port number. It is also assumed that the message 101 has not been preceded by any further message traffic, so that there is no “binding” for the network address Z or for the interface or port z in the network node device FW1. The arriving message 101 is not passed on from the network node device to the local area network LAN, and instead of this is rejected (discarded or dropped). In this case, as in the following figures, a drop process such as this is represented in the drawing by an irregular star.

In a second case, which is illustrated by a circled number 2 in FIG. 1, a second message 102 is assumed, which is transmitted within the local area network LAN from a transmitting element, not illustrated, which is annotated by the network address X or by the port x (“transmitter: X:x” in the drawing). The destination of the message 102 is assumed to be a receiving element, not illustrated, in the public network WAN, that is to say beyond the network node device FW1. The receiving network element is characterized by the network address Z and by the port z (“receiver: Z:z” in the drawing). The network node FW1 carries out an address translation or NAT (Network Address Translation) on the network address X, and passes the message 102 on in the form of a modified message 103 into the public network WAN. The modified message 103 is characterized in that the original sender network address X has been replaced by a modified sender address Y. The new sender address Y corresponds to the network address of the network node device FW1. In the course of passing on the message 102 into the public network WAN, in the form of the message 103, the network node device FW1 reserves a pass filter (pinhole), and calls a binding with a prior notification of the interface being used. With a network address Y used for the network node device FW1, this binding is:

X:x after Y:x and Y:x after Z:z.

This binding leads to each arriving data packet being transmitted with a sender address Z:z to an element with the network address X:x, and vice versa. The binding makes use of the originally used and retained port number. The time duration for a pass filter or a pinhole with an associated binding is normally limited in time, and is generally in the order of magnitude of about 30 seconds.

In a third case, which is illustrated in the drawing by a circled number 3, a transmitting element, not illustrated, is assumed, characterized by the network address Z′ and by the interface z′. The address/port combination Z′:z′ therefore differs from the address/port combination Z:z known from the second case. The transmitting element located in the public network area WAN sends a message 106 in the direction of an element, not illustrated, within the private network LAN. Although the binding described in case 2 still exists, the message 106 is rejected at the network node device FW1 since it has a combination of a network address and interface which does not match the previous binding.

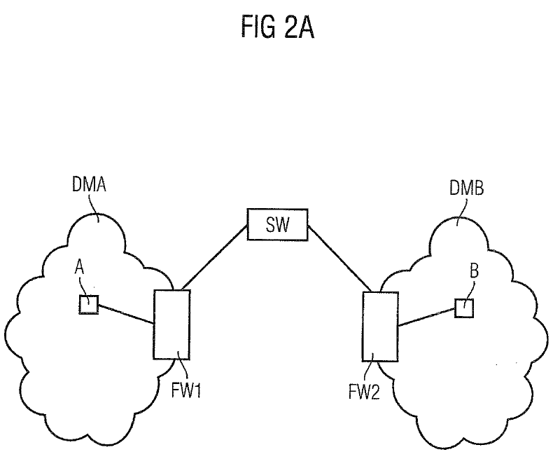

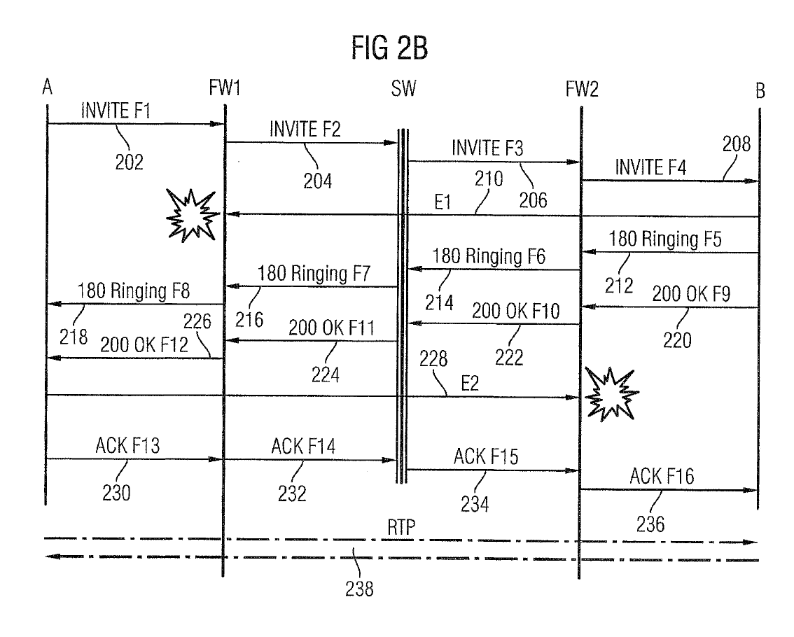

The method of operation, described with reference to FIG. 1, of a network node device which acts as a firewall between a public network WAN and a local area network LAN often prevents communication links from being set up which are managed, for example, on the basis of the SIP protocol. The problems which occur in this case will be described with reference to an arrangement as shown in FIG. 2a. The figure shows a first network area DMA or network domain DMA which is closed off or secured from other network areas by a first network node device FW1. A corresponding situation applies to a second network area DMB and a second network node unit FW2. A first network element A is arranged in the first network area DMA and then wishes to set up a communication with a second network element B which is arranged in the second network area DMB. The first network node unit FW1 is “connected” to the second network node unit FW2 via a further network node unit SW, which is also referred to in the following text as a switch.

By way of example, this is a packet-oriented switching device or, using an SIP protocol, an SIP server. A “connection” should in this case in principle not be understood as meaning a hard-wired connection in a packet-oriented network which intrinsically has no connections.

The following text is based on the assumption that the communication link between the two network elements A, B is set up using the SIP protocol. The use of the SIP protocol is, however, not essential for implementation of the method according to the invention. By way of example, alternative communication protocols can be used, for instance H.323.

A communication relationship between the two network elements A, B using the SIP protocol normally starts with a mutual interchange of their own network addresses. This interchange takes place using an SDP (Session Description Protocol) protocol which is associated with the SIP protocol family, and is normally accompanied by one or more invitation messages (“Invite”) and corresponding confirmation messages (“OK”).

In the invitation message, the calling network element A sends its own IP address and the associated port for incoming data traffic, for example speech, video data etc. In the confirmation message, the called network element B sends its own IP address and a port number for its incoming data traffic for the present data link (Session).

The arrangement shown in FIG. 2a in this case has two network node units FW1, FW2, which act as a firewall and adversely affect this interchange of SDP messages so that, in the worst case, no communication relationship is set up. This is because the respective network elements A, B send their own network address, which is known only locally, for the protocol SIP, that is to say a network address which is known only in the respective network area DMA, DMB, and which is translated by an NAT method by the respective network node device FW1, FW2 to a publicly known network address.

An NAT method furthermore provides address translation only in the header of the message or of the data packet, but not in the payload data part (“Body”) of the data packet, although this is used by the SIP protocols to define the communication partner. This problem is solved only slightly satisfactorily by means of “SIP aware” ALG (Application Layer Gateways) since they are characterized by a considerable loss of performance, since they have to investigate the body of every data packet.

The invention proposes that these problems be overcome inter alia by an extension to invitation and confirmation messages which are interchanged in the protocol, and this will be explained with reference to a flowchart as shown in FIG. 2B, and with further reference to the functional units shown in FIG. 2A. The flowchart should be understood chronologically in a vertical direction, so that later times are located further down than earlier times. A message interchange is shown in a horizontal direction, between the first network element A of the first network node unit FW1, the switch SW, the second network node unit FW2, and the second network element B.

The network addresses or IP addresses of the functional units involved are:

| | | |
|---|---|---|
| A: | 192.168.0.1 | Private address in DMA |
| FW1: | 195.1.1.0 | Public address |
| FW2: | 195.1.200.0 | Public address |
| UAS: | 192.168.170.1 | Private address in DMA |

In the course of setting up a communication link starting from the calling first network element A, this first network element A sends an invitation message 202 “Invite F1” in the direction of the second network element B to the first network node FW1, which passes the invitation message on in the form of a modified message 204 “Invite F2” to the switch. Since the network node device FW1 is not designed as a specific “Application Layer Gateway”, the content in the body of the invitation message 204 remains unchanged in comparison to the received invitation message 202. Instead of this, the network node device FW4 makes changes only in the header of the data packet, inter alia a network address translation, as explained in the description relating to FIG. 1. The content or SIP part of the invitation message 204 is received at the switch SW in the following form:

### F2

INVITE sip:fw1user@wcom.com SIP/2.0

### Via: SIP/2.0/UDP IPv6.com:5060

From: fw1user <sip:fw1user@wcom.com>
To: fw2user <sip:fw2user@wcom.com>
Call-ID: 12345678@wcom.com

### CSeq: 1 INVITE

. . .
v=0
s=Session SDP
c=IN IP4 192.168.0.1
t=3034423619 0
m=audio 49170/AVP 98
a=rtpmap:98 amr

The above message relates to the content of the message 204, but the header is not illustrated. The message, as before, contains the private address 192.168.0.1, which has not been changed by the network address translation process, of the calling network element A in the local network segment DMA. The port to be used for the network element A is specified as 49170.

The switch SW now overwrites the information contained in the SDP part within the invitation message 204, using the following rules:
the IP address within the SDP part is overwritten with the IP address in the IP header, which is also supplied with the invitation message 204, of the invitation message 204, which corresponds to the public network address of the network node unit FW1. In the present exemplary embodiment, this is the network address 195.1.1.0.
The interface number or port number within the SDP part of the invitation message 204 remains unchanged. Since the network node unit in the exemplary embodiment has a so-called “port persistance” characteristic, that is to say there are no changes to the port numbers, the port number sent with each invitation message 204 is also used locally by the network element A.

A correspondingly modified invitation message “Invite F3” 206 is sent from the switch to the second network node unit FW2. The invitation message 206 has the following structure:

### F3

INVITE sip:fw1user@wcom.com SIP/2.0

### Via: SIP/2.0/UDP IPv6.com:5060

From: fw1user <sip:fw1user@wcom.com>
To: fw2user <sip:fw2user@wcom.com>
Call-ID: 12345678@wcom.com

### CSeq: 1 INVITE

v=0
s=Session SDP
c=IN IP4 195.1.1.0
t=3034423619 0
m=audio 49170/AVP 98
a=rtpmap:98 amr

The above message relates to the content of the message 206, the header is not shown. The message now contains the public address 195.1.1.0, which has been modified by the switch SW on the basis of the rules mentioned above, for the first network node unit FW1. The port to be used for the network element A is entered, without any change, as 49170.

The invitation message 206 received by the second network node unit FW2 is processed analogously to the procedure, in particular NAT, at the first network node device FW1, and is sent in the form of the invitation message 208 “Invite F4” to the second network element B.

The invitation message 206 passes through the second network node unit FW2, since invitation messages normally use a default port number 5060 for signaling. The invitation message 206 is therefore passed on in the form of the invitation message 206 through the second network node unit FW2 using a “Port Forwarding Mechanism”.

In the course of receiving the invitation message 208 at the called second network element B, a UDP packet, or “Reverse UDP Packet”, which is sent in the opposite direction from the second network element B, is now according to the invention sent in the direction of the calling first network element A, in order to force a pass filter (pinhole) at the second network node unit FW2. This packet that is sent in the opposite direction is shown as the message 210 “E1”. As shown in the drawing, the message 210 is rejected at the first network node unit FW1, but on its way has opened a pass filter in the second network node unit FW2. This procedure not only opens a pass filter but also produces a binding in the second network node unit FW2. A port number is used and noted in advance as the transmitting port in the message 210 which is also used in the subsequent course of this communication session for reception of a payload data stream 238. This payload data stream, which is represented by dashed-dotted lines in the drawing, is transported by means of an RTP protocol (Real Time Protocol).

The further course of the communication session corresponds essentially to the requirements of the SIP protocol and relates to the messages 212, 214, 216, 218 (“Ringing F5” . . . “Ringing F8”) and 220 (“OK F10”).

The process of setting up a call by means of the messages follows the SIP protocol until the data contained in the SDP part of the confirmation message 222 has been received by the switch SW. The SDP part of the confirmation message 222 which is received at the switch SW (“200 OK F10”) in this case has the following structure:

### F10

### SIP/2.0 200 OK

From: fw1user <sip:fw1user@wcom.com>
To: fw2user <sip:fw2user@wcom.com>
Call-ID: 12345678@wcom.com

### CSeq: 1 INVITE

v=0
s=Session SDP
c=IN IP4 192.168.170.1
t=3034423619 0
m=audio 3456 RTP/AVP 98
a=rtpmap:98 amr

In this case, the local IP address 192.168.170.1 which is valid in the network area DMB for the called network element B is entered, as well as its port 3456.

The switch SW overwrites the SDP part of the confirmation message 222 using the following rules:
the IP address within the SDP part of the confirmation message 222 is overwritten with the IP address in the IP header of the confirmation message 222, which has previously been assigned by the second network node device FW2. This corresponds to the public network address of the second network node device FW2, which in the present exemplary embodiment has the value 195.1.200.0.
The port number within the SDP part of the confirmation message 222 is not changed.

On its departure, the SDP part of the confirmation message 224 has the following structure in accordance with the rules applied above:

### F11

### SIP/2.0 200 OK

From: fw1user <sip:fw1user@wcom.com>
To: fw2user <sip:fw2user@wcom.com>
Call-ID: 12345678@wcom.com

### CSeq: 1 INVITE

v=0
s=Session SDP
c=IN IP4 195.1.200.0
t=3034423619 0
m=audio 3456 RTP/AVP 98
a=rtpmap:98 amr
The content of the confirmation message 224 now includes the public address 195.1.200.0, which has been changed by the switch SW on the basis of the rules mentioned above, for the second network node unit FW1. The port to be used for the network element B is entered, unchanged, as 3456.

The confirmation message 224 received by the first network node unit FW1 is processed analogously to the procedure at the first and second network node device FW1, FW2, and is sent in the form of the confirmation message 226 “200 OK F12” to the first network element A.

At the time at which the confirmation message 226 arrives at the first network element A, the first network element A sends a further reverse UDP packet in the form of the message “E2” 228 in the direction of the second network element B. This message 228 analogously produces a pass filter and a binding in the first network node unit FW1. The message 228 is rejected at the second network node unit FW2.

From now on, a pass filter and a binding exist in both the network node units FW1, FW2 acting as a firewall.

As a consequence of this, a payload data stream 238 or RTP interchange (Real Time Protocol) can now be set up, which overcomes the limitations of the two firewalls, that is to say of the two network node units FW1, FW2, since bindings exist at both network node units FW1, FW2. There is now no need for network address translation between the switch and the two network node units FW1, FW2 for this payload data link 238.

The messages 228, 210 which produce a pass filter for the first and second network node devices FW1, FW2 are repeated if required, for example if the pass filter has already been closed because of the time restriction of the open state that has been mentioned, before it has been possible to set up the payload data link 238.

The “acknowledge” messages 230 . . . 236 which are provided according to SDP are normally sent following reception of the confirmation message, but have no significance for the method according to the invention.

The use of this exemplary embodiment of the method according to the invention is predicated only on the two network node units FW1, FW2 that are used making use of a “port preservation”, that is to say the port numbers do not change in the messages that are interchanged. This characteristic is widely used in modern network node devices FW1, FW2. The extensions which the method according to the invention provides with respect to the SIP protocol relate essentially to the use of two “reverse UDP packets”, that is to say the messages 210, 228. All that is required to implement these messages 210, 228 is a minor software modification in the network elements A, B.

The extensions provided to the SIP protocol optionally furthermore include a data field which indicates to the switch SW the rules which are described in advance that are or are not to be used.

A respective processing of the invitation and confirmation messages need not necessarily be carried out in a central instance such as the switch or an SIP registrar as described in the exemplary embodiment. Such processing can be carried out, for example, in other network elements by means of a peer-to-peer communication procedure between the network elements. These network elements are, for example, arranged analogously to the exemplary embodiment between the network domains DMA, DMB.

1. A method for data interchange between network elements, comprising:
arranging at least one calling network element and at least one network element to be called in different first and second network areas, which are separated by network node devices;
allocating the network elements a network address which is locally valid in the respective network area, and with the locally valid network address which is included in message header entries in messages which are sent by network elements being converted by the network node devices to a network address which is valid outside the respective network area;
transmitting at least one invitation message by the calling network element
modifying the content of the invitation message base on the network address which is included in the message header entry and is valid outside the first network area;
transmitting a message which produces a pass filter for the second network node device by the network element to be called, after receiving the invitation message;
transmitting at least one confirmation message by the network element to be called;
modifying the content of the confirmation message based on the network address which is included in the message header entry and is valid outside the second network area; and
transmitting a message which produces a pass filter for the first network node device by the network element to be called, after receiving the confirmation message.

2. The method as claimed in claim 1,
wherein the data interchange is a payload data link.

3. The method as claimed in claim 1, wherein the data interchange is used as a communication link.

4. The method as claimed in claim 1, wherein invitation and/or confirmation messages are configured in accordance with the SIP and/or SDP protocols.

5. The method as claimed in wherein transmitting the message which produces a pass filter for the second network node device and transmitting the message which produces a pass filter for the first network node device are repeated in order to obtain a payload data link.

6. A computer program product with program code for controlling a computer
to interchange data between network elements in which at least one calling network element and at least one network element to be called are arranged in different first and second network areas, which are separated by network node devices, with the network elements being allocated a network address which is locally valid only in the respective network area, and with the locally valid network address which is included in message header entries in messages which are sent by network elements being converted by the network node devices to a network address which is valid outside the respective network area, the computer program product comprising:
at least one invitation message is transmitted by the calling network element;
the content of the invitation message is modified on the basis of the network address which is included in the message header entry and is valid outside the first network area;
a message which produces a pass filter for the second network node device is transmitted by the network element to be called after receiving the invitation message;
at least one confirmation message is transmitted by the network element to be called;
the content of the confirmation message is modified on the basis of the network address which is included in the message header entry and is valid outside the second network area; and
a message which produces a pass filter for the first network node device is transmitted by the network element to be called, after receiving the confirmation message.

7. A network elements the network element performing the method of:
arranging at least one calling network element and at least one network element to be called in different first and second network areas, which are separated by network node devices;
allocating the network elements a network address which is locally valid in the respective network area, and with the locally valid network address which is included in message header entries in messages which are sent by network elements being converted by the network node devices to a network address which is valid outside the respective network area;
transmitting at least one invitation message by the calling network element;
modifying the content of the invitation message base on the network address which is included in the message header entry and is valid outside the first network area;
transmitting a message which produces a pass filter for the second network node device by the network element to be called, after receiving the invitation message;
transmitting at least one confirmation message by the network element to be called;
modifying the content of the confirmation message based on the network address which is included in the message header entry and is valid outside the second network area; and
transmitting a message which produces a pass filter for the first network node device by the network element to be called, after receiving the confirmation message.

8. A switch, the switch performing the method of:
arranging at least one calling network element and at least one network element to be called in different first and second network areas, which are separated by network node devices;
allocating the network elements a network address which is locally valid in the respective network area, and with the locally valid network address which is included in message header entries in messages which are sent by network elements being converted by the network node devices to a network address which is valid outside the respective network area;
transmitting at least one invitation message by the calling network element;
modifying the content of the invitation message base on the network address which is included in the message header entry and is valid outside the first network area;
transmitting a message which produces a pass filter for the second network node device by the network element to be called, after receiving the invitation message;
transmitting at least one confirmation message by the network element to be called;
modifying the content of the confirmation message based on the network address which is included in the message header entry and is valid outside the second network area; and
transmitting a message which produces a pass filter for the first network node device by the network element to be called, after receiving the confirmation message.
